(19) United States
(12) Patent Application Publication
(10) Pub. No.: US 2009/0304437 A1
(43) Pub. Date: Dec. 10, 2009

(54) CLAMP ARRANGEMENT

(75) Inventor: Sven-Ake Hurtig, Vastra Frolun (SE)

Correspondence Address: WRB-IP LLP, 1217 KING STREET, ALEXANDRIA, VA, 22314, US

(73) Assignee: VOLVO LASTVAGNAR AB, Goteborg (SE)

(21) Appl. No.: 11/577,096

(22) PCT Filed: Sep. 13, 2005
(86) PCT No.: PCT/SE2005/001332

§ 371 Date: May 7, 2009

(30) Foreign Application Priority Data
Oct. 12, 2004 (SE) 0402487-3

(51) Int. Cl. B62D 7/20; B62D 7/16

(52) U.S. Cl. 403/24; 403/290

(57) ABSTRACT

A clamp arrangement for a vehicle includes a shackle having two legs and a clamping device for clamping together and fixing a first threaded shaft section to a second threaded tubular section when the shackle is arranged on the second threaded tubular section in which the clamp arrangement includes a positioning device intended to interact with an opposing slot in the first threaded shaft section for rotationally locking the clamp arrangement in relation to the first threaded shaft section. A predefined orientation of a clamp arrangement in a clamped connection is permitted.

The present invention relates to a clamp arrangement for fixing a first threaded shaft section to a second threaded tubular section, in which the clamp arrangement comprises means for rotationally locking the clamp arrangement to the first threaded shaft section. The invention may advantageously be used in order to fix a ball joint to a tubular rod.

In order to be able to take up tolerances in steering tie rods, track rods and various stabilizer bars on a vehicle, for example, it is advantageous to be able to adjust the length of the rods. This is important, for example, when a track rod is to be adjusted in the production of a vehicle. If the track rod is not of the correct length the vehicle will not track correctly, which among other things leads to increased tire wear. The commonest way of adjusting a track rod is to design the ball joints with a threaded shaft section, which runs in a tubular rod having an internal thread. When adjusted to the correct length, the tubular rod is fixed to the threaded shaft section of the ball joint with a clamp. In order to allow the track rod to be clamped together, the end sections of the tubular rod are slotted. Clamps of this type are disclosed, for example, in DE 10031594 A1 and DE 19900264 A1.

These known clamps function excellent in most cases. In certain cases, however, according to how much space is available, the clamp may strike against another component, depending on how the clamp is aligned. It is desirable, therefore, to be able to orient the clamp in a predefined rotational position.

It is desirable to provide a clamp arrangement which permits a rotationally locked orientation of the clamp arrangement in relation to a shaft section.

According to an aspect of the present invention, a clamp arrangement for a vehicle comprises a shackle having two legs and a clamping device for tightening the clamp arrangement and fixing a first threaded shaft section to a second threaded tubular section when the shackle is arranged on the second threaded tubular section in that the clamp arrangement comprises a positioning device, intended to interact with an opposing slot in the first threaded shaft section for rotationally locking the clamp arrangement in relation to the first threaded shaft section.

This first embodiment of the clamp arrangement according to an aspect of the invention provides a clamp arrangement for a vehicle which permits a predefined rotational orientation of the clamp arrangement in relation to a shaft section. An advantage of this is that the clamp arrangement can be positioned in a predefined manner which prevents the clamp arrangement interfering with other components.

The invention is particularly advantageous in an aspect of the invention when it is applied to constructions having two threaded components which are connected to one another by way of these threads. Track rods on vehicles, for example, comprises a ball joint provided with a threaded shaft section which is arranged in an internally threaded rod for rotation of the ball joint and the threaded rod in relation to one another. After adjusting the length by turning, the clamp arrangement is used in order to lock the rod and the shaft section to prevent their relative rotation by clamping together the slotted end sections of the rod against the shaft section. The clamp arrangement according to the invention is preferably designed with a positioning device, which is intended to interact with an opposing slot in a shaft section, which is adjustably coupled to the component on which the clamp arrangement is arranged. Such a shaft section is usually situated in a position outside the shackle of the clamp arrangement, that is to say in a position which is axially offset in relation to the position of the shackle. In the case of the track rod this means that the positioning device can be designed to rotationally lock the shaft section of the ball joint and the clamp arrangement relative to one another, so that in the event of longitudinal adjustment, that is to say turning of the shaft section and the rod relative to one another, the orientation of the clamp arrangement in relation to the ball joint will be maintained. Such a positioning device may be furnished, for example, by providing the shackle with a pin, which projects from the shackle in an axial direction. The pin at its free end may furthermore have a part extending radially inwards, which can be placed in a slot in the shaft section. Such a pin will also be capable of locking the clamp arrangement to prevent axial movement (away from the ball joint) relative to the rod, in that the pin will come to bear against the end surface of the rod.

In an advantageous further development of the clamp arrangement according to an aspect of the invention the positioning device is conical and is provided with a radius on its bearing surface. The advantage of this is that the positioning device can interact with a milled or forged slot in the shaft section, which is easy and inexpensive to produce.

In another advantageous further development of the clamp arrangement according to the an aspect of invention the clamp arrangement comprises two positioning devices. The advantage of this is that the positioning becomes more reliable. Clamp arrangements having more than one positioning device located in different ways can furthermore be used in order to ensure that different clamp arrangements are used on the correct shaft section.

### BRIEF DESCRIPTION OF THE DRAWINGS

The invention will be described in more detail below with reference to exemplary embodiments, which are shown in the drawings attached, in which

FIG. 1 shows a clamp arrangement according to the invention and

FIG. 2 shows a clamp arrangement according to the invention fitted to a track rod.

### DESCRIPTION OF EMBODIMENTS

The exemplary embodiments of the invention and further developments described below must be regarded solely as examples and shall in no way limit the scope of the patent claims. In the exemplary embodiments here described the same reference numerals in the various drawings relate to the same type of part. Each part is therefore not described in detail in all exemplary embodiments.

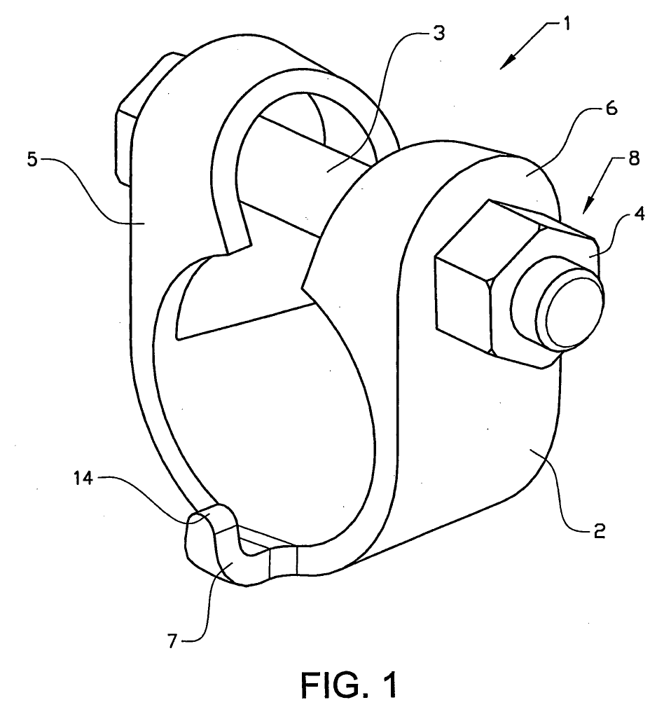

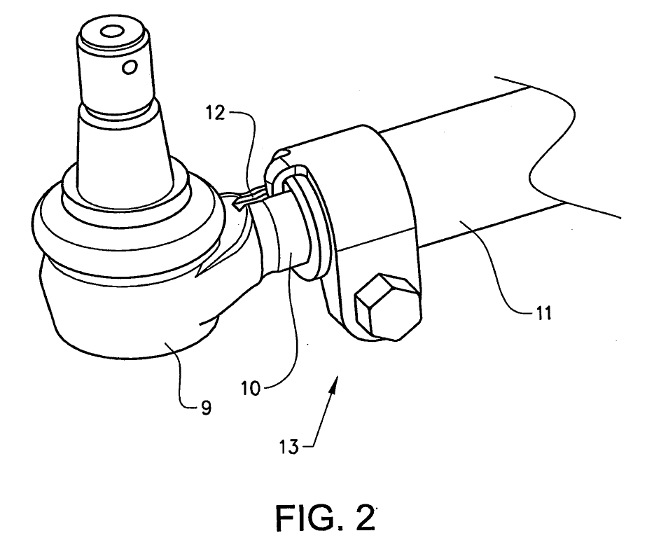

The clamp arrangement 1 for a vehicle shown in FIGS. 1 and 2 comprises a shackle 2 and a clamping device 8 in the form of a bolt fastener. The shackle is designed with a circular opening for enclosing a tubular rod and with two legs 5, 6. The legs 5, 6 are each provided with a hole, through which the bolt fastener 8 runs. The bolt fastener here comprises a bolt 3 and a nut 4. When the bolt fastener is tightened the diameter of the opening in the clamp arrangement will be reduced. When the clamp arrangement is fitted to a slotted tube, the tube will thereby be pressed together, thereby fixing the tube to a shaft section located in the tube. The tube and the shaft section are advantageously threaded, which permits a reliable fine adjustment of the shaft section in relation to the tube.

The clamp arrangement also comprises a positioning device 7, here in the form of a bent-down pin. The positioning device 7 is intended to interact with a shaft section 10, which is adjustably coupled to the component on which the clamp arrangement is arranged. In the example illustrated the pin 7 is intended to interact with a slot in the shaft section 10. This shaft section is preferably situated axially adjacent to the shackle, or in other words the shaft section with which the pin interacts is located in a position outside the shackle of the clamp arrangement, that is to say in a position which is offset in an axial direction 20 in relation to the position of the shackle. Since the pin 7 extends from the shackle 7 in an axial direction, that is to say in the longitudinal direction of the rod 11, the pin 7 can come into engagement with the shaft section 10 whilst the shackle 2 can bear against the rod 11 over its entire width. The bending of the pin 7 means that the pin in its free end has a part which is basically directed radially inwards and which is intended to engage with the slot 12 in the shaft section 10. FIGS. 1 and 2 illustrate the axial direction 20 and consequently the radial direction is conventionally perpendicular to this direction.

The pin 7 and the slot thereby allow the clamp arrangement 1 always to have the same predetermined position in relation to the shaft section, that is to say the clamp arrangement is rotationally locked in relation to the shaft section. The object of this is to prevent the legs and/or the bolt fastener interfering with other components of the vehicle, which may be the case when the clamp arrangement is fitted with an incorrect orientation relative to the shaft section. The pin 7 may be located anywhere around the shackle opening. The chosen position of the pin is determined by how the clamp arrangement is to be oriented in relation to the slot in the shaft section.

FIG. 2 shows a clamp arrangement 1 fitted to one end of a track rod 13. The track rod 13 comprises a tubular rod 11 with a ball joint 9 at each end. One end of the track rod is shown here, comprising a ball joint 9 with a shaft section 10 and a tubular rod 11. The shaft section 10 is threaded with a suitable thread which matches an internal thread in the tubular rod 11. The tubular rod is furthermore slotted (not shown) at the end section, so that it can be clamped together. When the tubular rod 11 is to be fixed to the shaft section 10, the clamping device of the bolt fastener is tightened so that the internal thread of the tubular rod is pressed against the thread of the shaft section.

When the length of the track rod is to be adjusted, the bolt fastener is slackened somewhat. The tubular rod is then rotated as far as necessary. Since the positioning device 7 interacts with the slot 12, the clamp arrangement will follow the movement of the shaft section 10, so that the clamp arrangement assumes the same orientation in relation to the ball joint 9 throughout the entire adjustment process. When the adjustment is completed, the bolt fastener is tightened again. Since the clamp arrangement is always oriented in the same way in relation to the shaft section, this facilitates fitting whilst at the same time preventing the clamp arrangement from interfering with external components, such as the vehicle front axle, for example. The positioning device 7 furthermore ensures that the clamp arrangement is positioned at the end of the tubular rod, since the positioning device 7 prevents the clamp arrangement being shifted axially towards the middle of the tubular rod, that is to say away from the ball joint 9.

It would also be possible to use a shaft section and a tubular rod without threads. The advantage of threads is firstly that fixing the rod to the shaft section is rendered more reliable and secondly that a fine adjustment of the length of the tubular rod can be performed in a more reliable manner.

In a further development of the clamp arrangement according to the invention the positioning device is of conical shape. Giving the positioning device a conical shape means that any tolerances in the positioning device and in the slot can be compensated for. Giving the bearing surface 14 of the positioning device against the slot a radius that corresponds to the radius of the slot also improves the bearing against the bottom of the slot.

In another further development of the clamp arrangement according to the invention the clamp arrangement comprises two positioning devices. Using two positioning devices increases the reliability of the orientation of the clamp coupling, should one positioning device be damaged, for example. Locating the positioning devices asymmetrically, that is to say adjusting the positioning devices to interact with slots that are located asymmetrically in the shaft section allows different clamp arrangements to be adjusted to different shaft sections. The asymmetry serves to prevent a clamp arrangement being fitted in the incorrect place. This is advantageous, for example, where the accessible space is dependent upon the location, that is to say when the clamp arrangement must have a different orientation depending on how it is located.

The invention must not be regarded as being limited to the exemplary embodiments described above, a number of further variants and modifications being feasible without departing from the scope of the following patent claims. For example, the clamp arrangement may also be used for other types of clamped connection in which a shaft section and a tubular element are to be fixed to one another.

1. A clamp arrangement for a vehicle, comprising a shackle having two legs and a clamping device for tightening the clamp arrangement and fixing a first threaded shaft section to a second threaded tubular section when the shackle is arranged on the second threaded tubular section, wherein the clamp arrangement comprises a positioning device adapted to interact with an opposing slot in the first threaded shaft section for rotationally locking the clamp arrangement in relation to the first threaded shaft section.

2. The clamp arrangement as claimed in claim 1, wherein the positioning device comprises a pin integrated with the shackle.

3. The clamp arrangement as claimed in claim 1, wherein the positioning device is conical.

4. The clamp arrangement as claimed in claim 1, wherein the positioning device is provided with a radius in a bearing section thereof.

5. The clamp arrangement as claimed in claim 1, wherein the clamp arrangement comprises two positioning devices adapted to interact with two opposing slots in a shaft section.

6. The clamp arrangement as claimed in claim 1, wherein the clamping device comprises a bolt and a nut.

7. The clamp arrangement as claimed in claim 1, wherein the clamp arrangement is made of a metallic material.

8. A rod for a vehicle, comprising a ball joint and a rod, wherein the rod comprises a clamp arrangement as claimed in claim 1 for rotationally locking the clamp arrangement to the ball joint.

9. The rod as claimed in claim 8, wherein the rod comprises two ball joints and two clamp arrangements.

10. The clamp arrangement as claimed in claim 2 wherein the positioning device is conical.

11. The clamp arrangement as claimed in claim 2, wherein the positioning device is provided with a radius in a bearing section thereof.

12. The clamp arrangement as claimed in claim 2, wherein the clamp arrangement comprises two positioning devices adapted to interact with two opposing slots in a shaft section.

13. The clamp arrangement as claimed in claim 2, wherein the clamping device comprises a bolt and a nut.

14. The clamp arrangement as claimed in claim 2, wherein the clamp arrangement is made of a metallic material.

15. The clamp arrangement as claimed in claim 3, wherein the positioning device is conical.

16. The clamp arrangement as claimed in claim 3, wherein the positioning device is provided with a radius in a bearing section thereof.

17. The clamp arrangement as claimed in claim 3, wherein the clamp arrangement comprises two positioning devices adapted to interact with two opposing slots in a shaft section.

18. The clamp arrangement as claimed in claim 3, wherein the clamping device comprises a bolt and a nut.

19. The clamp arrangement as claimed in claim 3, wherein the clamp arrangement is made of a metallic material.

20. The clamp arrangement as claimed in claim 4, wherein the positioning device is conical.
